(19) United States
(12) Patent Application Publication
(10) Pub. No.: US 2026/0219844 A1
(43) Pub. Date: Jul. 30, 2026

(54) ASSOCIATING CODE WITH A VISUALIZATION OBJECT

(71) Applicant: JPMorgan Chase Bank, N.A., NEW YORK, NY (US)

(72) Inventors: John C. Tyler, West Chester, PA (US); Yaroslav Bogatov, BERKSHIRE (GB); Nabaa F. Al-Alawi, UXBRIDGE (GB); Joshua A. Mohamed, London (GB); Mark E. Petterson, WEMBLEY (GB); Yukui McDonald, Bear, DE (US)

(73) Assignee: JPMorgan Chase Bank, N.A., NEW YORK, NY (US)

(21) Appl. No.: 19/039,660

(22) Filed: Jan. 28, 2025

(51) Int. Cl. G06F 8/30

(52) U.S. Cl. CPC G06F 8/30

(57) ABSTRACT

There are provided systems, methods, and non-transitory computer-readable media for associating code with visualization objects. For instance, there is provided a system that includes a processor and a memory. The memory includes instructions, which when executed, cause the processor to perform certain operations. The operations include generating a visualization object in-line with an underlying code and automatically updating the visualization object in response to a change in the underlying code.

### TECHNICAL FIELD

The present disclosure relates to systems and methods for associating code with a visualization object. More particularly, the present disclosure relates to dynamically and automatically maintaining a connection between a visualization object and a code.

### BACKGROUND

In application development, one essential step is to define and provision application infrastructure through code. This practice is termed infrastructure as code (IaC), and it allows repeatable and consistent deployment of the application, or generally, of an application suite, across different environments. For instance, according to an IaC paradigm, one may build a desired cloud infrastructure by provisioning configuration files that describe the necessary components required for executing the application. Such components may include servers, networks, and storage.

IaC cloud environments for corporate-scale projects may span a large number of files that may be included in a repository or scattered across multiple repositories. Navigating such a complex infrastructure is cumbersome and error prone. For example, such navigation may entail the use of plain text queries across multiple repositories. This process is not only inefficient, but it can return non-specific information; thus, it can cause errors in the deployment cycle.

Further, while state-of-the-art cloud providers may offer visualization options to help alleviate some of the above-noted issues, the typical complexity of the underlying infrastructure precludes the linking of these visualization options (e.g., diagrams and dependency trees) with the actual source code. Furthermore, even when limited to a particular repository, these visualization options still lack functionality because they can also fail to provide links back to the source code.

### SUMMARY

The embodiments featured herein help solve or mitigate the above-noted issues as well as other issues known in the art. For example, embodiments described herein provide hardware, software, systems thereof, and methods to automatically and/or dynamically maintain visualization objects in line with source code, across a plurality of repositories, with links to one or more blocks of code, and with corresponding descriptions describing one or more elements of said one or more block of codes. Furthermore, embodiments described herein build infrastructure diagrams bounded and cross-referenced to the IaC source code across multiple repositories to maintain up-to-date documentation. Moreover, embodiments described herein provide visual aids for navigating individual component dependencies.

There are provided exemplary embodiments that include systems, methods, and non-transitory computer-readable media. For instance, in one exemplary embodiment, there is provided a system that includes a processor and a memory. The memory includes instructions, which when executed, cause the processor to perform certain operations. The operations include generating a visualization object in-line with an underlying code and automatically updating the visualization object in response to a change in the underlying code.

In another exemplary embodiment, there is provided a system that includes a processor and a memory. The memory includes instructions, which when executed by the processor, cause the processor to perform certain operations. The operations include generating a visualization object in-line with an underlying code and automatically updating the underlying code in response to a change in the visualization object.

The system of any preceding clause, wherein the underlying code is an IaC framework; and wherein the underlying code is a source code.

The system of any preceding clause, wherein the visualization object includes a component that maintains a link to a corresponding part of the underlying code; wherein the operations are integrated into a continuous integration (CI) pipeline.

The system of any preceding clause, wherein the operations are integrated in an Integrated Development Environment (IDE).

The system of any preceding clause wherein the operations further include generating one or more links respectively corresponding to one or more operations of the underlying code; and wherein the one or more links are incorporated in the visualization object.

The system of any preceding clause, wherein the operations are integrated in a version control system.

In yet another exemplary embodiment, there is provided a method residing as instructions on a non-transitory computer-readable medium. The instructions are configured to cause a processor of a system to perform certain operations. The operations include generating a visualization object in-line with an underlying code and automatically updating the underlying code in response to a change in the visualization object.

The method of any preceding clause, wherein the operations further include providing the underlying code as an IaC; and wherein the operations further include providing the underlying code as a source code.

The method of any preceding clause, wherein the operations further include providing a component in the visualization object that maintains a link to a corresponding part of the source code; and wherein the operations further include generating one or more links respectively corresponding to one or more portions of the underlying code.

In yet another exemplary embodiment, there is provided a method residing as instructions on a non-transitory computer-readable medium. The instructions are configured to cause a processor of a system to perform certain operations. The operations include generating a visualization object in-line with an underlying code and automatically updating the underlying code in response to a change in the visualization object.

The non-transitory computer-readable medium of any preceding clause, wherein the operations further include providing the underlying code as an IaC; and wherein the operations further include providing the underlying code as a source code.

The non-transitory computer-readable medium of any preceding clause, wherein the operations include providing a component in the visualization object that maintains a link to a corresponding part of the underlying code; and wherein, wherein the operations further include generating one or more links respectively corresponding to one or more portions of the underlying code.

Additional features, modes of operation, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to people skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates conventional visualization solutions used in conjunction with IaC.

FIG. 2 illustrates a system interfacing with an underlying code according to an exemplary embodiment of the present disclosure.

FIG. 3 illustrates a visualization object according to an exemplary embodiment.

FIG. 4 illustrates another visualization object according to an exemplary embodiment.

FIG. 5 illustrates yet another visualization object according to an exemplary embodiment.

FIG. 6 illustrates a block diagram of an exemplary control system configured for implementing one or more embodiments of the present disclosure.

FIG. 7 illustrates a flow chart of an exemplary method of practicing an embodiment of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

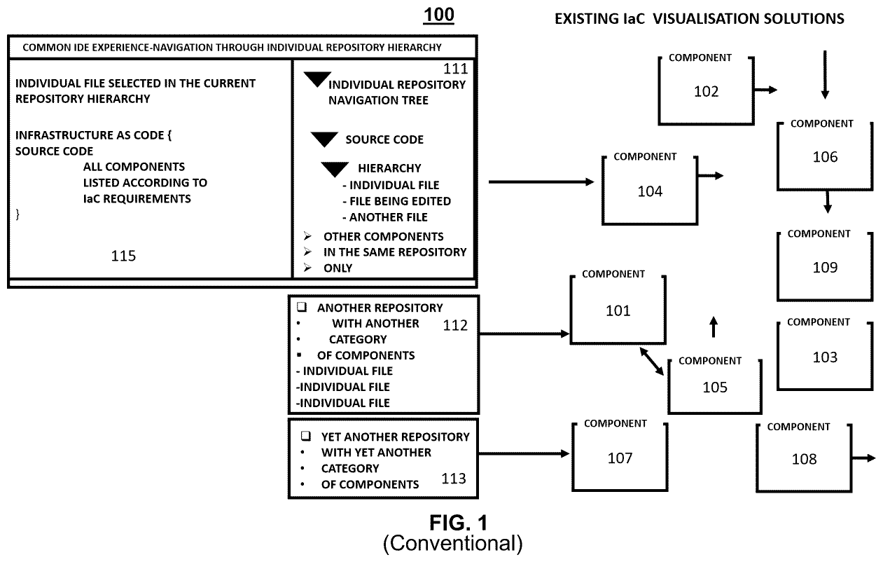

FIG. 1 illustrates a conventional visualization solution 100 used in conjunction with IaC. In the solution 100, a source code may be located in one or more repositories (e.g., repositories 111, 112, and 113). Via interface 115, a user may select a file to be edited. The file may be found by the user parsing through the current repository hierarchy.

For instance, the repository hierarchy may include dependent or independent repositories 111, 112, and 113. Once selected, a visualization object, such as component 104, may be generated corresponding to the file being edited. In this typical example, the component 104 only offers a limited view as it does not give information on the hierarchy and the architecture of the underlying code.

Similarly, once selected, other files in the repositories 111, 112, and 113 may be visualized as single components (101, 102, 103, 105, 106, 107, 108, and 109). But in each case, there is no understanding that can be gained from the visualization object as they do not provide an all-encompassing view of the source code. Furthermore, in the typical visualization solution 100, an update in the source code file does not automatically translate to the visualization component. Furthermore, a visualization component cannot be edited to effect a corresponding change in the file(s) with which it is associated.

The embodiments provided in the present disclosure help mitigate these aforementioned issues. For instance, in one exemplary embodiment, a system may include hardware and software components configured to provide automatic and dynamic visualization for IaC source codes. Visualization objects may include architectural diagrams that convey the architecture of an IaC source code. In the embodiment, said architectural diagrams may be “live.” In other words, they may be updated seamlessly as the underlying source code changes. By example, and not by limitation, a visualization object may include text boxes, pull-down menus, icons, links, and/or other items that can provide interaction capability to a user.

Furthermore, when integrated into an IDE, the visualization infrastructure provided by the embodiment may serve as a pass-through to update the underlying source code to which it links. The source code may be located in file structures spread across multiple repositories. These repositories may reflect dependencies associated with different modules or different functional units of the source codes. In the embodiment, the visualization infrastructure may be configured to account for such file structure complexity, providing seamless organizational and functional representations of the underlying source codes.

Generally, without departing from the teachings of the present disclosure, an embodiment as described herein may be applied to any data that can be represented using visualization tools that can be linked to the whole data or to one or more parts thereof. In other words, one of ordinary skill in the art will readily recognize that the embodiments presented herein are not limited to IaC source codes and their corresponding architectural diagrams.

In general, the teachings presented herein can be applied to any data that can be represented graphically and to any visualization that can be linked to the underlying data in part or in whole. Furthermore, a visualization component may be a graphical representation of a file or set of files, which may be achieved via a widget provisioned by a graphical user interface (GUI) system.

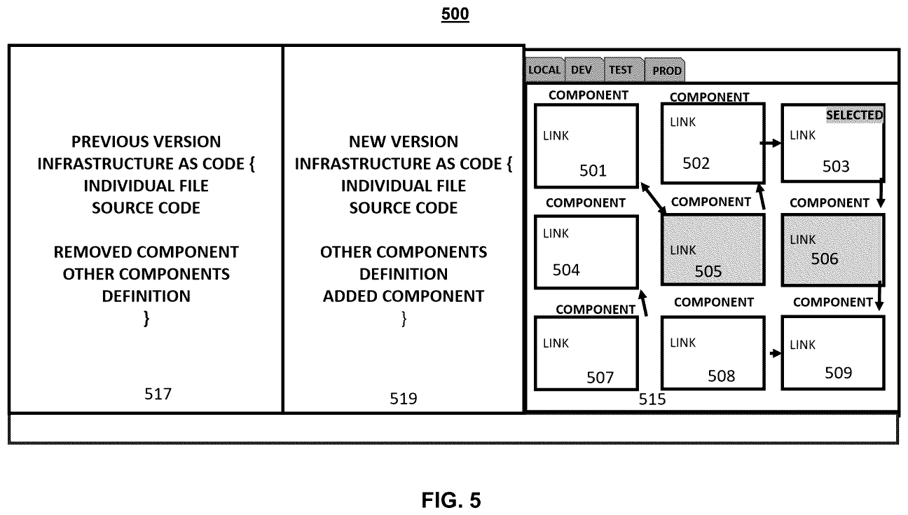

Source code for the IaC framework may be maintained in individual repositories managed by a version control system (see FIG. 5). Moreover, one or more software systems that may be included in the embodiments do not impose any limitations on code format, maintenance practice, policies, and procedures. Furthermore, according to the embodiments, the IaC framework can be applied to create a target infrastructure with or without the software systems noted above.

Architectural diagrams of the infrastructure may be maintained through the software systems to ensure that all relevant components described by the source code are added, modified, or removed from the visualization in line with source code edits. In the embodiments, structured text formats for storage of all intermediate and final files may be used to describe one or more architectural diagrams.

Furthermore, individual edits to source code may be treated as patches, and those patches can be translated and applied to intermediate and final files, thus maintaining version control of the architectural diagram in line with the source code. It should be noted that mechanisms to maintain changes in sync between the source code and diagram can vary. For example, some IaC frameworks, according to the embodiments, may provide their own visualization tools. In these scenarios, output differences from one version to another can be automatically extracted to generate incremental updates to the architectural diagrams.

Architectural diagrams allow manual re-arranging of rendered components, and they provide additional information not required for the IaC system functionality. Such additional information can be stored in code comments or separate files ensuring that the data necessary to re-create the diagram in full are maintained, and they are always available in a repository.

Furthermore, architectural diagrams may be rendered with interactive components linking visual blocks to the underlying code. For example, and not by limitation, this may be implemented using hypertext links embedded into a scalable vector graphics (SVG) diagram. It should be noted that mechanisms of navigation between the visualization and the code are not limited to hypertext links and may vary. For example, in an IDE, selecting an individual component on the diagram can automatically navigate to the relevant source code section in a corresponding code editor.

Furthermore, architectural diagrams may be rendered by incorporating source code from all repositories relevant to a particular infrastructure. For example, and not by limitation, this may be achieved using a configuration file explicitly listing all relevant repositories. It should be noted that a particular mechanism of discovering relevant repositories can vary and is not limited to manual or static configurations. For example, and not by limitation, relevant repositories can be discovered through version control system search or other methods of automated code analysis readily understood by one of ordinary skilled in the art.

Moreover, the integration of the software systems into CI pipelines may also be achieved. This allows automatically maintaining documentation in line with the code. Architectural diagrams can be stored and maintained in the version control system, for example, and not by limitation, in README.MD files. Architectural diagrams may also be automatically exported into external documentation systems, for example, as wikis and/or confluence pages.

Generally, according to the embodiments, the integration of the one or more software systems in an IDE can allow navigation across the source code through architectural diagrams. For example, this may be achieved by selecting diagram blocks to navigate to the relevant source code sections or by presenting a user with relevant source code sections directly on the architectural diagram. This can allow in-place code edits and live updates of the diagram. Furthermore, due to the discrete incremental nature of diagram updates, it is also possible to highlight such updates on the visualization thus illustrating code differences. This can be used in code review and code version comparison to highlight changes in the whole infrastructure diagram.

One exemplary embodiment uses the Terraform™ IaC source code to define bespoke components targeting the Amazon™ Web Services (AWS) cloud utilizing diagrams built using PlantUML™. An output of the embodiment may be a diagram including stock infographics and/or hyperlinks to one or more local repositories. By example, and without limitation, a format of the output may be a .SVG file or an SVG object. The embodiment may have a modular architecture so that it may be extended to support other source and output formats as well as alternative parsing and visualization libraries.

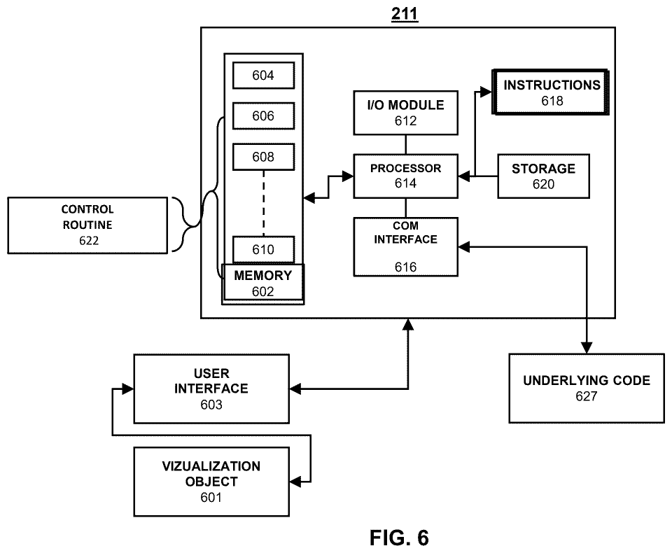

Furthermore, in one exemplary embodiment, there may be provided a method to associate the diagram with the IaC source code in an in-line fashion, i.e., with live bidirectional connectivity between the diagram and the IaC source code. This may be achieved using a method residing as instructions in a memory of a control system (see FIG. 6). The method may include reading all files from a set of directories. Each directory may represent a separate workspace. Each workspace may contain a set of infrastructure definitions which may be described as modules and/or resources. Each module may have a reference to its own source definition.

The method may then include creating a virtual map of all workspaces, modules, and resources. This map may be built by analyzing each module and resource for its dependencies, which may be other modules and resources, and which may be located in other workspaces. Building this map may include iterating over an entire list of modules and resources. The iteration may be configured to retrieve the dependencies and determine whether they are already in a list of known modules and resources.

Creating the virtual map may further include creating links back to the original files and directors. Furthermore, in another step, the method may include translating the map into a visual diagram. For each module and resource, the method may include looking up in an internal table the appropriate visual icon to represent that piece of the infrastructure (e.g., database, function, or queue icons).

Dependencies may be accounted for in the visual diagram by the method drawing a line between two or more icons. Furthermore, the method may include identifying the workspace that each module or resource is defined in. For example, this may be achieved by making the modules of a “workspace 1” a different color than the module of a “workspace 2”. Furthermore, for each module or resource, the method may create hyperlinks to the source file that it was defined in. Without departing from the teaching of the disclosure, this exemplary method may be achieved in Terraform, or any other IaC platform.

Further, in one exemplary embodiment, text formats used at each step of processing may enable incremental merging of changes into existing diagrams. This feature can allow manual diagram editing and automatic upkeep with the source code through typical version conflict resolution processes. Furthermore, information required for visualization may be sorted alongside IaC files and maintained within the same version control system. Moreover, synchronization may be ensured through CI pipeline rules similar to analyzers and quality gates used for source codes.

Furthermore, in one exemplary embodiment, contemplated storage formats and/or mechanisms of synchronization may vary. These formats and/or mechanisms may be configured to ensure automatic version conflict resolution and maintenance of visualization cross-referencing the source code. Moreover, in the embodiment, the visualization tools may be integrated into an IDE module to provide diagram links that give direct access to files, allowing live editing of relevant sections for one or more components.

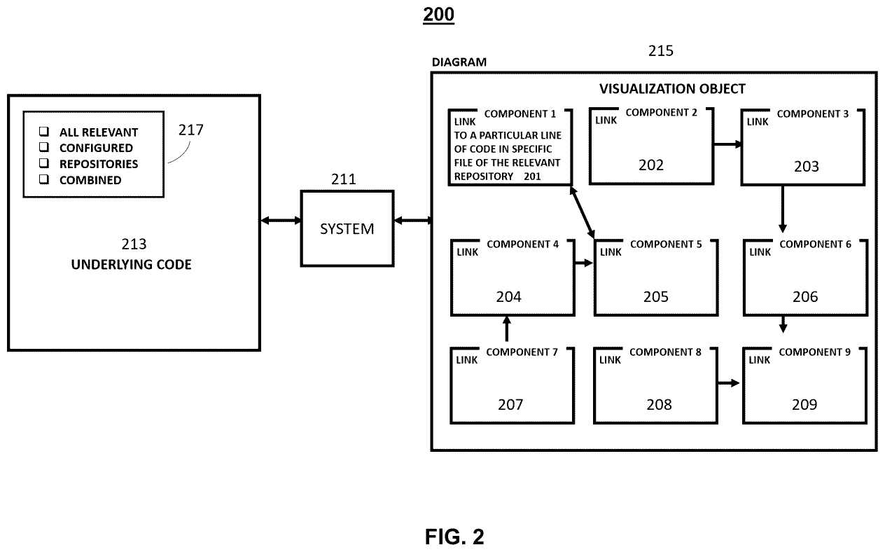

These exemplary embodiments and their features may be further understood when considering FIG. 2, which shows an exemplary implementation 200. In FIG. 2, an exemplary system 211 is configured to provide bi-directional, dynamic, or automatic connectivity between an underlying code 213 and a visualization object 215. The visualization object 215 may be an architectural diagram that is a representation of a subset 217 of all relevant configured repositories of the underlying source code 213 combined, or it may be a representation of the entire underlying source code, or generally, it may represent a subset of the underlying source code. Furthermore, the visualization object 215 provides a hierarchical and organizational view of the underlying source code 213 via components 201, 202, 203, 204, 205, 206, 207, 208, and 209, for each of which a link is provided. The link may be a mechanism for seamlessly retrieving the file or the set of files corresponding to a component.

Moreover, in the exemplary implementation 200, editing a file in the underlying code 213 is automatically and dynamically accounted for by the system 211, and such a change is also automatically and dynamically updated in the visualization object 215. Here, editing generally means any change in the underlying code 213, whether it be at the file level or at architectural levels (e.g., through a change of file or repository dependencies).

Similarly, when visualization object 215 is integrated into an IDE or a CI pipeline, a change (as described above) may be made directly from the visualization object 215. In that case, the system 211 is provisioned to automatically and dynamically effect the corresponding change in the underlying code 213.

The visualization object 215 may also be integrated into version control systems, thereby allowing the preservation of states of the underlying code 213 and further providing the ability to revert to a previous state. In that case, reversion from one state to another state automatically reconfigures both the underlying code 213 and the visualization object 215 accordingly. Further descriptions of the system 211 are discussed below with respect to FIG. 6.

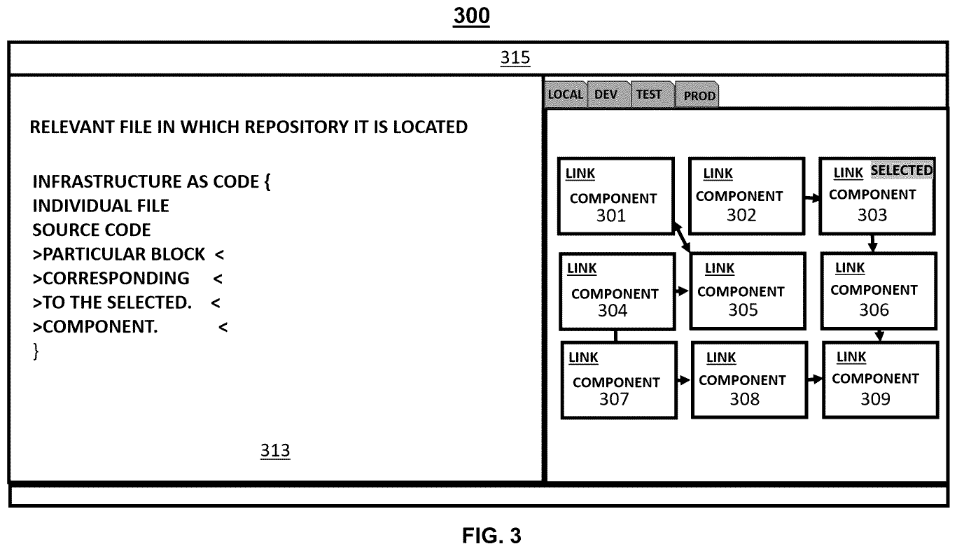

FIG. 3 illustrates yet another exemplary implementation 300 wherein the system 211 of FIG. 2 provides seamless and improved integration with IDE, facilitating code navigation through live updates at the component level. As noted above, in this type of integration, updates can be made directly via a visualization object 315. The visualization object 315 includes a plurality of visualizations of components 301, 302, 303, 304, 305, 306, 307, 308, and 309. Changes in architecture, or at the file level, can be done live either at the source code 313 or at the visualization object 315. In either case, the system 211 is configured to dynamically update either the source code 313 or the visualization object 315 to reflect the update. Furthermore, instances of the source code 313 can be created to run locally, or in development mode, in test mode, or to deploy in a production mode.

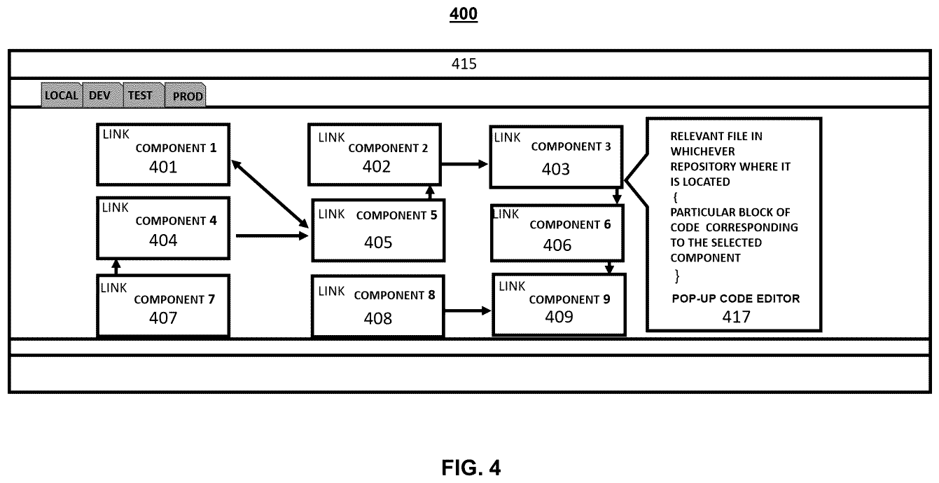

FIG. 4 illustrates yet another exemplary implementation 400 wherein the system 211 of FIG. 2 provides the capability for “visualization first implementations.” In other words, the system 211 may provide an architectural diagram 415 (including components 401, 402, 403, 404, 405, 406, 407, 408, and 409). The architectural diagram 415 can be accessed for a pop-up code editor 417 to provide direct editing of the underlying code 213. Furthermore, instances of the source code 313 can be created to run locally, in development mode, in test mode, or to deploy in a production mode. FIG. 5 illustrates yet another exemplary implementation 500 wherein the system 211 of FIG. 2 provides the capability for an improved code review experience via visualization of diagram changes. In this implementation, versions of the underlying code (e.g., versions 517 and 519) may be retrieved and their corresponding visualization objects 515 tiled to show architectural changes. Components 501, 502, 503, 504, 505, 506, 507, 508, and 509 that were changed from one version to another may be highlighted for comparison. Furthermore, instances of the source code 517, 519 can be created to run locally, in development mode, in test mode, or to deploy in a production mode.

FIG. 6 describes an implementation of the exemplary system 211 of FIG. 2 configurable to execute the various methods and processes described above. The embodiments are not limited to the computer architecture embodied within the exemplary system 211. Other computer architectures that are well known to those of skill in the art, such as a modified Harvard architecture as one example, may be used and are within the spirit and scope of the present disclosure.

In the system 211 (e.g., a computer system or control system), each or all of the various methods described herein may be implemented. These various methods include, for example, generating a visualization object in-line with an underlying code and automatically updating the visualization object in response to a change in the underlying code or vice versa.

These methods may be embodied as instructions that can cause the system 211 to perform operations configured to associate code or data with visualization objects. For example, the various methods may be embodied as instructions residing in a non-transitory component such as a memory or a storage device associated with the system 211. That is, the structure of the system 211 is imparted by the methods described herein in the form of instructions.

The system 211 may be an application-specific hardware, software, and firmware implementation (or a combination thereof) configured to execute the exemplary methods described herein. The system 211 may be a structural and application-specific system configured with the structural features and providing the functions described above. The system 211 can include a processor 614 configured to execute one or more, or all of the blocks of the exemplary methods described previously.

The processor 614 can have a specific structure imparted thereto by instructions stored in a memory 602 and/or by instructions 618 fetchable by the processor 614 from a storage medium 620. The storage medium 620 may be co-located with the system 211 as shown, or it can be remote and communicatively coupled to the system 211. Such communications may be encrypted.

The system 211 may be a stand-alone programmable system, or a programmable module included in a larger system. For example, the system 211 can be included as part of an IDE or a version control system. Also, the system 211 may include one or more hardware and/or software components configured to fetch, decode, execute, store, analyze, distribute, evaluate, and/or categorize information.

The processor 614 may include one or more processing devices or cores (not shown). In some embodiments, the processor 614 may be a plurality of processors, each having either one or more cores. The processor 614 can execute instructions fetched from the memory 602, i.e., from one of memory modules 604, 606, 608, or 610. Alternatively, the instructions can be fetched from the storage medium 620, or from a remote device connected to the system 211 via a communication interface 616. An input/output (I/O) module 612 may be configured for additional communications to or from remote systems or to a user interface 603 from which the processor 614 may receive a set of requirements. Such additional communications may be facilitated by a communications interface 616.

Without loss of generality, the storage medium 620 and/or the memory 602 can include a volatile or non-volatile, magnetic, semiconductor, tape, optical, removable, non-removable, read-only, random-access, or any type of non-transitory computer-readable computer medium.

The storage medium 620 and/or the memory 602 may include programs and/or other information usable by processor 614, such as, for example, instructions that enable the processor 614 to generate a visualization object in line with an underlying code and automatically update the visualization object in response to a change in the underlying code. Such instructions may also automatically update the underlying code in response to a change effected via the visualization object. Furthermore, the storage medium 620 can be configured to log data processed, recorded, or collected during the operation of the system 211.

The data may be time-stamped, location-stamped, cataloged, indexed, encrypted, and/or organized in a variety of ways consistent with data storage practice. By way of example, the memory modules 604 to 610 can form instructions that embody the implementations discussed previously. In other words, the memory modules 604 to 610 may form control routine 622 that can cause the processor 614 to perform certain operations upon execution. For example, the operations can include generating a visualization object 601 in-line with an underlying code 627 and automatically updating the visualization object 601 in response to a change in the underlying code 627 or vice versa. The visualization object 601 may be a representation of a certain set of memory addresses as generated by the underlying code (627) and interpreted by an operating system also stored in the memory 602. Generally, the visualization object 601 may be part of the user interface 603.

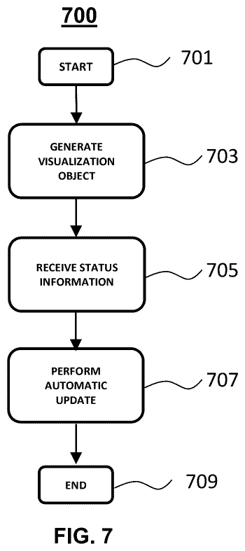

FIG. 7 illustrates a flowchart of an exemplary method 700 according to an embodiment. The method 700 may be executed by a system, such as the system 211 of FIGS. 2 and 6. The method 700 may begin at a step 701, and it may include generating at step 703, by the system, a visualization object. The method 700 may include receiving at step 705, by the system, status information. The status information may be an indicator that a change in an underlying code (such as the underlying code 213 of FIG. 2) has occurred. In another scenario, the status information may be an indicator that a change in the visualization object has occurred. Upon receiving the status information at step 705, the method 700 can include performing at step 707, by the system, an automatic update. In one scenario, when the status information indicates that a change in the underlying code has occurred, step 707 can include automatically updating the visualization object. In another scenario, when the status information indicates that a change in the visualization object has occurred, step 707 can include automatically updating the underlying code. The method ends at step 709.

Having described well-detailed embodiments including systems, methods, and non-transitory computer-readable media, the teachings of the present disclosure are now described according to general exemplary embodiments featuring some of or all of the features described previously. For instance, in one general embodiment, there is provided a system that includes a processor and a memory. The memory includes instructions, which when executed, cause the processor to perform certain operations. The operations include generating a visualization object in-line with an underlying code and automatically updating the visualization object in response to a change in the underlying code.

In another embodiment, there is provided a system that includes a processor and a memory. The memory includes instructions, which when executed by the processor, cause the processor to perform certain operations. The operations include generating a visualization object in-line with an underlying code and automatically updating the underlying code in response to a change in the visualization object.

In yet another embodiment, there is provided a method residing as instructions on a non-transitory computer-readable medium. The instructions are configured to cause a processor of a system to perform certain operations. The operations include generating a visualization object in-line with an underlying code and automatically updating the visualization object in response to a change in the underlying code.

In yet another embodiment, there is provided a method residing as instructions on a non-transitory computer-readable medium. The instructions are configured to cause a processor of a system to perform certain operations. The operations include generating a visualization object in-line with an underlying code and automatically updating the underlying code in response to a change in the visualization object.

In yet another embodiment, there is provided a non-transitory computer-readable medium including instructions configured to cause a processor of a system to perform certain operations. The operations include generating a visualization object in line with an underlying code and automatically updating the visualization object in response to a change in the underlying code.

In yet another embodiment, there is provided a non-transitory computer-readable medium including instructions configured to cause a processor of a system to perform certain operations. The operations include generating a visualization object in-line with an underlying code and automatically updating the underlying code in response to a change in the visualization object.

In the above-noted exemplary embodiments, the underlying code may be an IaC framework, and it may be a source code. Furthermore, the visualization object can include a component that maintains a link to a corresponding part of the source code. The operations are integrated into a CI pipeline. The operations may be integrated into an IDE framework. Furthermore, the operations can further include generating one or more links respectively corresponding to one or more portions of the underlying code. One or more links may be incorporated into the visualization object. The operations can further include locating one or more repositories containing the underlying code to generate the visualization object. Lastly, the operations may be further integrated into a version control system.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded with the broadest scope consistent with the principles and novel features disclosed herein.

Those skilled in the relevant art(s) will appreciate that various adaptations and modifications of the embodiments described above can be configured without departing from the scope and spirit of the disclosure. Therefore, it is to be understood that, with in the scope of the appended claims, the disclosure may be practiced other than as specifically described herein.

1. A system, comprising:
a processor;
a memory including instructions, which when executed by the processor, cause the processor to perform operations including:
generating a visualization object in-line with an underlying code; and
automatically updating the visualization object in response to a change in the underlying code.

2. The system of claim 1, wherein the underlying code is an Infrastructure as Code (IaC) framework.

3. The system of claim 2, wherein the underlying code is a source code.

4. The system of claim 3, wherein the visualization object includes a component that maintains a link to a corresponding part of the source code.

5. The system of claim 1, wherein the operations are integrated in a continuous integration (CI) pipeline.

6. The system of claim 1, wherein the operations are integrated in an Integrated Development Environment (IDE).

7. The system of claim 1, wherein the operations further include generating one or more links respectively corresponding to one or more portions of the underlying code.

8. The system of claim 7, wherein the one or more links are incorporated in the visualization object.

9. The system of claim 1, wherein the operations further include locating one or more repositories containing the underlying code to generate the visualization object.

10. The system of claim 1, wherein the operations are integrated in a version control system.

11. A method, residing as instructions on a non-transitory computer-readable medium, the instructions configured to cause a processor of a system to perform operations comprising:
generating a visualization object in-line with an underlying code; and
automatically updating the visualization object in response to a change in the underlying code.

12. The method of claim 11, wherein the operations further include providing the underlying code as an Infrastructure as Code (IaC).

13. The method of claim 12, wherein the operations further include providing the underlying code as a source code.

14. The method of claim 13, wherein the operations further include providing a component in the visualization object that maintains a link to a corresponding part of the source code.

15. The method of claim 11, wherein the operations further include generating one or more links respectively corresponding to one or more portions of the underlying code.

16. A non-transitory computer-readable medium including instructions configured to cause a processor of a system to perform operations comprising:
generating a visualization object in-line with an underlying code; and
automatically updating the visualization object in response to a change in the underlying code.

17. The non-transitory computer-readable medium of claim 16, wherein the operations further include providing the underlying code as an Infrastructure as Code (IaC).

18. The non-transitory computer-readable medium of claim 17, wherein the operations further include providing the underlying code as a source code.

19. The non-transitory computer-readable medium of claim 18, wherein the operations further include providing a component in the visualization object that maintains a link to a corresponding part of the source code.

20. The non-transitory computer-readable medium of claim 16, wherein the operations further include generating one or more links respectively corresponding to one or more portions of the underlying code.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
